(19) United States
(12) Patent Application Publication
(10) Pub. No.: US 2024/0397971 A1
(43) Pub. Date: Dec. 5, 2024

(54) METHOD FOR PREPARATION OF FULLY SOLUBLE LEGUME PROTEINS USING MEDIA MILL COUPLED WITH ULTRASOUND

(71) Applicant: NANCHANG UNIVERSITY, NANCHANG (CN)

(72) Inventors: JUN CHEN, NANCHANG (CN); TAOTAO DAI, NANCHANG (CN); CHANGHONG LI, NANCHANG (CN); LIZHEN DENG, NANCHANG (CN); CHENGLIANG LV, NANCHANG (CN); CHENGMEI LIU, NANCHANG (CN)

(21) Appl. No.: 18/327,077

(22) Filed: Jun. 1, 2023

(51) Int. Cl. A23J 3/14; A23J 3/16; A23L 33/185; B02C 19/18

(52) U.S. Cl. CPC A23J 3/14; A23J 3/16; A23L 33/185; B02C 19/18

(57) ABSTRACT

The present disclosure provides a method for preparing fully soluble legume protein using a combination of stirred media mill and ultrasound technology. This method belongs to the field of food processing technology. The steps involved in this method includes: (1) mixing commercial legume protein with distilled water at a certain mass fraction (5-20%); (2) pouring the stirred protein solution into a colloid mill for coarse grinding, resulting in a coarse grinding solution; (3) heating the coarse grinding protein solution; and (4) pouring the heated, after cooling, into a media mill-ultrasonic coupling system for simultaneous grinding and ultrasonication, wherein the protein solution that has been ground and ultrasonicated is the high-solubility legume protein.

### TECHNICAL FIELD

The present disclosure relates to a method for preparation of fully soluble legume proteins using media mill coupled with ultrasound, and belongs to the technological field of food processing, especially to protein modification technology.

### BACKGROUND

With the rapid increase in population, people's demand for protein is growing. Legume protein is an important vegetable protein resource, which contains more than 18 kinds of amino acids and is rich in lysine that is lacking in cereal protein, with balanced nutrition and nutritional value close to animal protein. In addition, legume protein is economically efficient, and the cost of obtaining the same quality of legume protein is much lower than that of pork, beef, chicken, and eggs. However, compared to animal proteins, legume proteins as plant proteins have the disadvantage of low solubility, especially commercial legume proteins denatured by high temperature spray, which seriously affects their commercial application potential. To expand the functionality of legume proteins and improve their application value, there is an urgent need to improve the solubility of legume proteins.

Enzymatic, chemical, and physical modifications are currently available to modify the protein molecular structure and thus improve the solubility and functional properties of proteins. Enzymatic hydrolysis is an effective means to improve protein solubility. However, small molecule peptides are usually obtained after enzymatic hydrolysis of the proteins, which do not possess the functional properties of large molecule proteins, such as gelation. Also, enzymatic hydrolysis produces bitter substances that reduce the range of protein applications. For chemical methods, a glycosylation reaction may lead to a decrease in the purity of the protein and browning, which can affect the appearance, taste, and application of the product. Further, many by-products are generated during the glycosylation reaction. In recent years, a pH cycling method in combination with other methods is popular, CN 115251225 A discloses a method to improve the solubility of chickpea protein. Specifically, the method includes: mixing chickpea isolate protein and other miscellaneous bean isolate proteins, adjusting the pH of the mixed protein solution to 9.0-13.0, stirring at room temperature to keep the pH stable for 1-6 hours, adjusting the pH to 7.0, and obtaining binary composite chickpea isolate protein by dialysis and lyophilization. This method increases the solubility of the chickpea protein from 49.99% to 75.03% at the highest. However, such methods usually require the addition of large amounts of alkali and acid to shift the pH to extreme acid-base environments (e.g. pH 2, pH 12), which do not meet the needs of green production, and also require dialysis and lyophilization techniques, which increase production costs and make it difficult to meet the actual food processing needs. CN201810964282.5 discloses a method for preparation of instant soy protein powder, which includes extraction, separation, acid precipitation, water washing, neutralization, sterilization, drying, micronization and other steps. This method also involves multiple times separation with alkali extraction and acid precipitation and other processing method steps, such that the process is complex and high energy consumption.

Stirred media mill is widely used in building materials, coatings, chemicals, pharmaceuticals, food, pesticides, electronics, metallurgy, ceramics, pigments and other fields, with many superior characteristics, such as preparation of ultra-fine particles, high efficiency, energy saving, low pollution, easy operation, According to the direction (vertical or horizontal) of a grinding chamber during operation, the stirred media mill can be divided into a vertical stirred media mill and a horizontal stirred media mill. The stirred media mill drives the microfine grinding media and the materials to be ground to make multidimensional and rotating movements through the high-speed rotation of a stirring wheel in the grinding chamber. In this process, the grinding media and materials in the grinding chamber are positionally shifted constantly up and down and left and right, to produce intense movement. The crushing effect is achieved through the extrusion, impact, and shearing exerted by the grinding media on the particles, and the fineness of the final product can reach submicron particle size or even nanometer particle size.

Physical method has the advantages of green, suitable for industrial production, etc., However, its modification effect in modifying proteins is very limited, and often lower than the enhancement effect of chemical and enzymatic modification. Therefore, providing an efficient, green, and simple method to improve the solubility of legume proteins has become an urgent challenge for experts in the field.

### SUMMARY OF THE DISCLOSURE

### Technical solution

In view of this, the present disclosure provides a method for preparation of fully soluble legume protein that is simple to operate, does not introduce reagents, and is highly efficient and environmentally friendly. The present disclosure provides a feasible solution for increasing solubility of commercial legume proteins and can provide a theoretical basis for the deep processing of legume proteins, thus broadening the functional properties and applications of legume proteins.

In an aspect, the present disclosure provides a method for preparation of fully soluble legume protein, wherein high-solubility legume protein is prepared by processing low-solubility legume protein with a physical method that combines grinding coupled with ultrasound.

In some embodiments, the method includes:
(1) providing legume protein, adding water and stirring to disperse evenly, and obtaining a protein dispersion;
(2) pouring the stirred homogeneous protein dispersion into a colloid mill for coarse grinding to obtain a coarse grinding solution;
(3) heating the coarsely ground protein solution; and
(4) cooling the heated coarsely ground protein solution, and pouring into a media mill-ultrasonic coupling system for grinding and ultrasonication; wherein the protein solution that has been ground and ultrasonicated is the high-solubility legume protein.

In some embodiments, the legume protein is un-pretreated legume protein with an initial solubility of 8%-20%; preferably, the legume protein is human and animal edible protein; more preferably the legume protein comprises one or more of pea protein, soy protein, mung bean protein, chickpea protein, black bean protein, lentil protein, fava bean protein, white kidney bean protein, navy bean protein, macaoba bean protein, butter bean protein, and lima bean protein.

In some embodiments, in the step (1), a mass fraction of protein in the protein dispersion is in a range of 5%-20%; a stirring rate is 300-900 r/min and a stirring duration is 10-30 min.

In some embodiments, in the step (2), a rotational speed of the colloid mill is 2000-4000 rpm, and the coarse grinding is performed for 1-3 times.

In some embodiments, in the step (3), a heating temperature is 50-90° C. and a heating duration is 1-3 h.

In some embodiments, the grinding tool applied is a media mill; in the media mill, the type, density, diameter, media filling rate of the grinding media, stirring rotor line speed, slurry concentration, slurry flow rate, type and amount of dispersant, etc. will affect the number of interactions between the grinding media and grinding strength (momentum) of the media upon the particles per unit of time, which in turn affects the final product fineness. For soy protein, the size and homogeneity of the particles after fine milling have a significant effect on the electrostatic interaction force between the particles, agglomeration ability, dispersion ability, and flavor.

In some embodiments, a grinding media in the media mill is glass beads, ceramic beads, steel beads; preferably the grinding media is ceramic beads, the ceramic beads being one or more of zirconium silicate beads, alumina beads, pure zirconia beads, rare earth metal stabilized zirconia beads, silicon nitride beads.

In some embodiments, the grinding media in the media mill is zirconia beads, the zirconia beads having a particle size of 0.1-3.0 mm, and the particle size may be 0.1-0.2, 0.2-0.3; 0.3-0.4, 0.4-0.6, 0.6-0.8, 0.8-1.0, 1.0-1.2, 1.2-1.4, 1.4-1.6. 1.6-1.8, 1.8-2.0, 2.0-2.2, 2.2-2.4, 2.4-2.6, 2.6-2.8, 2.8-3.0 mm, of course the beads may have not a single fixed size, but a mix of various ranges of sizes, for example, 0.2-2.0 mm, 0.8-1.8 mm, 1.8-3.0 mm.

In some embodiments, based on the characteristics of different grinding media beads, grinding time, and particle size, the filling rate of the grinding media beads in the media mill is selected within the range of 30-90%. Preferably, the preferred filling rate range is 40-85%.

In some embodiments, in the step (4), zirconia beads with a diameter of 0.6-1.8 mm are added to the grinding chamber, and a filling rate of the zirconia beads in the grinding chamber is 40%-80%; a motor speed in the grinding chamber is 600-1500 rpm; ultrasonic conditions include: a 10 mm diameter probe with a power of 800 W and a frequency of 35 kHz; the coarse grinding solution is circulated for 0.5-3 h; a grinding temperature is controlled at 30-50° C.

In some embodiments, in the step (5), the high-solubility legume protein has a solubility greater than 80%; preferably greater than 90%, more preferably greater than 95%, and greater than 98%.

In some embodiments, the high-solubility legume protein solution in the step (5) can be further processed into the form of protein emulsion, protein powder, protein granules, protein semi-solid gel, etc., in a technical means manner that is well known to those skilled in the art. Emulsifiers such as oils and fats, surfactants, starch, polysaccharides can be added during the preparation of emulsions, and emulsions are formed by means of mixing and homogenization. The preparation of protein solution into protein powder can be achieved by spray drying, hot air drying, freeze drying, etc. Various polymers such as PVA, CMC, PEG, polymeric polysaccharides, cellulose, etc. can also be added during the preparation of protein granules and semi-solid gels.

In some embodiments, the fully soluble legume protein has a solubility of greater than 80%, greater than 90%, greater than 91%, greater than 92%, greater than 93%, greater than 94%, greater than 95%, greater than 96%, greater than 97%, greater than 98%, greater than 99% in aqueous solution.

In another aspect, due to the excellent solubility of legume protein prepared by the present disclosure, it can be used in the preparation of feed, feed additives, food, beverages, pharmaceuticals, health food, nutritional supplements, food additives, cosmetics, and chemical products. The chemical products can be plastics, paints, and other industrial products that require the application of legume protein as a raw material.

In another aspect, the present disclosure further provides a media mill-ultrasonic coupling system, including: a temperature control machine (1), a media mill-ultrasonic coupling device (201), the temperature control machine (1) and the media mill-ultrasonic coupling device (201) being connected through a temperature control water circulation pipeline (5); the media mill-ultrasonic coupling device (201) includes a grinding motor (2), a grinding chamber-ultrasonic coupling section (3), an ultrasonic control panel (4), a temperature gauge (6), a material liquid circulation pipeline (7), a feed barrel stirring motor (8), a feed barrel (9), a staging tank (10), and a circulation pump (11); wherein an end of the grinding chamber-ultrasonic coupling section (3) is connected to the grinding motor (2), and grinding is performed in the grinding chamber (12) by the grinding motor (2) driving a grinding part, and an ultrasonic generation device (13) is configured to perform an ultrasonic action in the grinding chamber (12); the temperature gauge (6) is arranged on an upper part of the grinding chamber, the grinding chamber is connected to the staging tank (10) through the liquid circulation pipeline (7), and the circulation pump (11) disposed below the staging tank is configure to drive to circulate the material liquid; the feed barrel (9) is connected to the grinding chamber through a feed pipe, and the feed barrel stirring motor (8) is arranged in the feed barrel.

In another aspect, the present disclosure further provides an application of the media mill-ultrasonic coupling system in preparing fully soluble legume protein.

### Beneficial Effect

For legume proteins, the present disclosure develops a media mill-ultrasonic coupling system (FIG. 5), by which commercial legume proteins with low solubility can be modified to a solubility as high as 98% at high concentration to achieve total solubility of commercial legume proteins. The present disclosure provides an efficient and green physical modification method that can increase the solubility of 10% pea protein solution from 12.95% to 99.16%, and the supernatant protein content up to 86.63 mg/mL; the solubility of soy protein from 14.32% to 98.82%; the solubility of mung bean protein from 9.99% to 98.64%; the solubility of chickpea protein from 13.17% to 98.61%, etc. The solubility of commercial legume proteins is all significantly enhanced after treatment to reach the state of total solubility.

The technical means of the present disclosure do not introduce any chemical and organic reagents, and the legume protein with ultra-high solubility can be obtained by physical treatment only, which is far more effective than the existing technology, and is a green, natural, and efficient modification means. Further, the legume protein obtained by the method of the present disclosure has more excellent functional properties, such as emulsification and gelation, which can further expand the application value of legume protein in the food industry.

### BRIEF DESCRIPTION OF THE DRAWINGS

FIG. 1 is a schematic diagram illustrating the solubility of legume protein after treatment according to the present disclosure.

FIG. 2 is a schematic diagram illustrating the solubility of pea protein after treatment with different concentrations according to the present disclosure.

FIG. 3 shows the apparent and particle size changes of the pea protein prepared by the present disclosure after 30 days of storage.

FIG. 4 is a schematic diagram illustrating the particle size distribution of pea protein after treatment according to the present disclosure.

FIG. 5 is a schematic view of a media mill-ultrasonic coupling system.

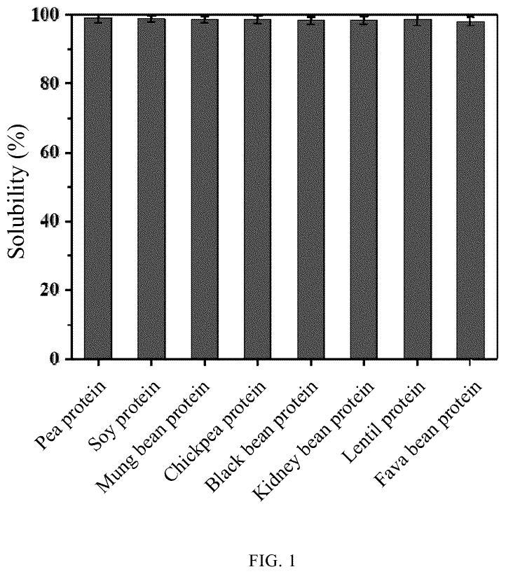

### NUMERAL REFERENCE

1. temperature control machine, 2. grinding motor, 3. grinding chamber-ultrasonic coupling device, 4. ultrasonic control panel, 5. temperature control water circulation pipeline, 6. temperature gauge, 7. material liquid circulation pipeline, 8. feed barrel stirring motor, 9. feed barrel, 10. staging tank, 11. circulation pump, 12. grinding chamber, 13. ultrasonic generation device; 201 media mill-ultrasonic coupling device.

### DETAILED DESCRIPTION

To make the object, technical solutions, and advantages of the present disclosure more clearly understood, the present disclosure is described in further detail hereinafter in conjunction with embodiments. It can be understood that the specific embodiments described herein are intended only to explain the present disclosure and are not intended to limit it.

### Embodiment 1

A method for preparation of fully soluble legume proteins using media mill coupled with ultrasound, including the following operations.
(1) selecting commercial pea protein, adding distilled water in proportion, and magnetically stirring into a homogeneous dispersion with a mass fraction of protein of 10% (w/w); where the pea protein is directly purchased commercial unhydrolyzed pea protein.
(2) pouring the stirred homogeneous protein solution into a colloid mill for 3 times of treatment to obtain a coarsely ground solution, where the speed of the colloid mill is 3000 rpm.
(3) heating the coarsely ground protein solution at 60° C. for 3 h.
(4) cooling the heated protein solution, and pouring into a media mill-ultrasonic coupling system for grinding, where the grinding media is zirconia beads with a diameter of 1.2-1.4 mm, the filling rate is 70%, the speed of the stirring motor is 400 rpm to stir the protein solution sample; the speed of the grinding motor is 1000 rpm, the ultrasonic power is 800 W, and the frequency is 35 kHz; the protein solution is cyclically ground for 2 h, with the grinding temperature of 45° C.
(5) the protein that has been ground and ultrasonicated is the fully soluble protein solution.

Further, the solubility of the fully soluble protein solution is determined, specifically: centrifuging the protein solution at 10,000 g for 20 min, and taking a supernatant and the whole solution to determine the protein content by Kjeldahl method. The solubility of the pea protein solution prepared by the method of the present disclosure is determined to be 99.16%.

### Embodiment 2

Embodiment 2 is the same as the method of Embodiment 1, except that the difference is that the protein is commercial soy protein, and the solubility of soy protein solution prepared by the method of the disclosure reaches 98.82%.

### Embodiment 3

Embodiment 3 is the same as the method of Embodiment 1, except that the difference is that the protein is commercial mung bean protein, and the solubility of the mung bean protein solution prepared by the method of the present disclosure reaches 98.64%.

### Embodiment 4

Embodiment 4 is the same as the method of Embodiment 1, except that the difference is that the protein is commercial chickpea protein, and the solubility of the chickpea protein solution prepared by the method of the present disclosure reaches 98.61%.

### Embodiment 5: Effect of Treatment with Media Mill-Ultrasonic Coupling System with Different Parameters on Legume Proteins

This embodiment is the same as the method of Embodiment 1, with the difference that after the pea protein is coarsely ground by the colloid mill and heated, it is further treated by the media mill-ultrasonic coupling system under different parameters, where the speed parameters include 600, 800, 1000, 1500, 2000, and 2500 rpm, and the media bead sizes include 1.8-2.0, 1.6-1.8, 1.2-1.4, 0.6-0.8, 0.4-0.6, and 0.2-0.4 mm, and Table 1 below shows the solubility of protein under different conditions at 70% filling rate of the grinding media.

The solubility of pea protein under each parameter is tested and the results are shown in Table 1 below. It can be seen that the parameters in the media mill coupling device have an obvious effect on the modification effect, where higher speed and smaller grinding bead size can greatly enhance the solubility of ground protein.

TABLE 1
Solubility of pea protein under different
conditions at 70% media filling rate

| | Rotational speed | | | | | |
|---|---|---|---|---|---|---|
| | 600 | 800 | 1000 | 1500 | 2000 | 2500 |
| Size | rpm | rpm | rpm | rpm | rpm | rpm |
| 1.8-2.0 mm | 36.45% | 36.86% | 38.46% | 38.79% | — | — |
| 1.6-1.8 mm | 54.12% | 60.56% | 76.48% | 81.74% | 83.34% | — |
| 1.2-1.4 mm | 57.35% | 74.13% | 86.26% | 99.16% | 99.26% | 98.45% |
| 0.6-0.8 mm | 56.78% | 71.42% | 85.45% | 95.76% | 95.98% | 94.15% |
| 0.4-0.6 mm | 40.51% | 42.87% | 45.98% | 48.45% | 54.56% | 60.89% |
| 0.2-0.4 mm | 30.42% | 31.02% | 32.42% | 32.42% | 35.46% | 40.68% |

This embodiment is the same as the method of Embodiment 1, with the difference that after the pea protein is coarsely ground by the colloid mill and heated, it is further treated by the media mill-ultrasonic coupling system under different parameters, where the speed parameters include 600, 800, 1000, 1500, 2000, and 2500 rpm, and the media bead sizes include 1.8-2.0, 1.6-1.8, 1.2-1.4, 0.6-0.8, 0.4-0.6, and 0.2-0.4 mm, and Table 2 below shows the solubility of protein under different conditions at 80% filling rate of the grinding media.

The solubility of pea protein under each parameter is tested and the results are shown in Table 2 below. It can be seen that the parameters in the media mill coupling device have an obvious effect on the modification effect, and continuing to increase the filling rate of the grinding media beads starting from 70% slightly improves the solubility of protein, but not significantly.

TABLE 2
Solubility of pea protein under different
conditions at 80% media filling rate

| | Rotational speed | | | | | |
|---|---|---|---|---|---|---|
| | 600 | 800 | 1000 | 1500 | 2000 | 2500 |
| Size | rpm | rpm | rpm | rpm | rpm | rpm |
| 1.8-2.0 mm | 37.46% | 38.94% | 40.56% | 42.56% | — | — |
| 1.6-1.8 mm | 56.35% | 69.31% | 78.74% | 85.46% | 84.62% | — |
| 1.2-1.4 mm | 59.35% | 77.56% | 87.16% | 99.14% | 99.45% | 98.75% |
| 0.6-0.8 mm | 59.54% | 79.23% | 86.79% | 96.98% | 96.54% | 95.24% |
| 0.4-0.6 mm | 42.63% | 46.23% | 47.68% | 51.75% | 58.16% | 61.89% |
| 0.2-0.4 mm | 31.35% | 33.12% | 33.56% | 33.52% | 35.65% | 41.54% |

This embodiment is the same as the method of Embodiment 1, with the difference that after the pea protein is coarsely ground by the colloid mill and heated, it is further treated by the media mill-ultrasonic coupling system under different parameters, where the speed parameters include 600, 800, 1000, 1500, 2000, and 2500 rpm, and the media bead sizes include 1.8-2.0, 1.6-1.8, 1.2-1.4, 0.6-0.8, 0.4-0.6, and 0.2-0.4 mm, and Table 3 below shows the solubility of protein under different conditions at 60% filling rate of the grinding media.

The solubility of pea protein under each parameter is tested and the results are shown in Table 3 below. It can be seen that the parameters in the media mill coupling device have an obvious effect on the modification effect, and reducing the filling rate of the grinding media mill will reduce the effect of protein solubility enhancement.

TABLE 3
Solubility of pea protein under different
conditions at 60% media filling rate

| | Rotational speed | | | | | |
|---|---|---|---|---|---|---|
| | 600 | 800 | 1000 | 1500 | 2000 | 2500 |
| Size | rpm | rpm | rpm | rpm | rpm | rpm |
| 1.8-2.0 mm | 31.87% | 32.56% | 35.66% | 36.56% | — | — |
| 1.6-1.8 mm | 46.51% | 52.12% | 62.56% | 64.89% | 69.36% | — |
| 1.2-1.4 mm | 47.75% | 58.35% | 69.45% | 84.25% | 84.46% | 87.56% |
| 0.6-0.8 mm | 43.67% | 59.46% | 68.62% | 85.43% | 85.33% | 86.44% |
| 0.4-0.6 mm | 35.76% | 38.45% | 40.76% | 42.73% | 47.28% | 52.75% |
| 0.2-0.4 mm | 29.12% | 32.23% | 33.46% | 33.86% | 34.56% | 39.46% |

This embodiment is the same to the method of Embodiment 1, with the difference that after the pea protein is coarsely ground by the colloid mill and heated, it is further treated by the media mill-ultrasonic coupling system under different parameters, where the speed parameters include 600, 800, 1000, 1500, 2000, and 2500 rpm, and the media bead sizes include 1.8-2.0, 1.6-1.8, 1.2-1.4, 0.6-0.8, 0.4-0.6, and 0.2-0.4 mm, and Table 4 below shows the solubility of protein under different conditions at 50% filling rate of the grinding media.

The solubility of pea protein under each parameter is tested and the results are shown in Table 4 below. It can be seen that the parameters in the media mill coupling device have an obvious effect on the modification effect, and reducing the filling rate of the grinding media mill will reduce the effect of protein solubility enhancement.

TABLE 4
Solubility of pea protein under different
conditions at 50% media filling rate

| | Rotational speed | | | | | |
|---|---|---|---|---|---|---|
| | 600 | 800 | 1000 | 1500 | 2000 | 2500 |
| Size | rpm | rpm | rpm | rpm | rpm | rpm |
| 1.8-2.0 mm | 29.47% | 31.56% | 32.54% | 34.25% | — | — |
| 1.6-1.8 mm | 39.74% | 42.56% | 52.56% | 59.75% | 61.37% | — |
| 1.2-1.4 mm | 40.64% | 46.78% | 53.65% | 71.42% | 75.64% | 80.65% |
| 0.6-0.8 mm | 39.17% | 42.76% | 50.42% | 75.45% | 76.95% | 81.65% |
| 0.4-0.6 mm | 31.54% | 32.43% | 33.56% | 38.62% | 41.61% | 45.14% |
| 0.2-0.4 mm | 24.45% | 27.45% | 30.63% | 31.82% | 31.84% | 30.65% |

### Embodiment 6: Effect of Speed of the Colloid Mill on the Preparation of Fully Soluble Legume Proteins using Media Mill Coupled with Ultrasound

This embodiment is the same as the method of Embodiment 1, with the difference that the speed of the colloid mill is changed to 1000, 1500, 2000, 2500,3500, 4000, 5000, 6000 rpm.

TABLE 5
Effect of different rotational speeds of the colloid
mill on the preparation of fully soluble proteins

| Speed (rpm) | Solubility |
|---|---|
| 1000 | 91.13% |
| 1500 | 92.61% |
| 2000 | 95.36% |
| 2500 | 98.57% |
| 3000 | 99.16% |
| 4000 | 99.22% |
| 5000 | 98.64% |
| 6000 | 98.88% |

From Table 5, it can be concluded that the rotational speed of the colloid mill in the range of 2000-6000 rpm can ensure that the solubility can reach more than 95%, and further increasing the speed above 4000 is not significantly helpful to enhance the solubility. Therefore, the best choice of speed is in 2000-4000 rpm.

### Comparisons 1-4

Comparisons 1-4 are selected from different types of legume proteins treated in the same way as step (1) of the method of Example 1 to obtain dispersions, with the difference that these protein dispersions are not treated with colloid mill, heating, and media mill-ultrasonic coupling system, and then centrifuged to determine the solubility of these bean proteins. The results are shown in Table 6 below.

TABLE 6
Solubility of different types of legume proteins treated by
conventional methods and the method of the present disclosure

| | Protein | Elevation of the |
|---|---|---|
| | solubility of | present disclosure |
| Comparison | Comparison | over the Comparison |
| Comparison 1 (pea protein) | 12.95% | 86.21% |
| Comparison 2 (soy protein) | 14.32% | 84.50% |
| Comparison 3 (mung bean protein) | 9.99% | 88.65% |
| Comparison 4 (chickpea protein) | 13.17% | 85.44% |

Embodiments 1-4 and Comparisons 1-4 show that the use of a combined treatment with the colloid mill, heating, and media mill-ultrasonic coupling system can substantially increase the solubility of legume protein.

### Comparison 5

This embodiment is the same as the method of Embodiment 1, with the difference that the pea proteins are not subjected to colloid mill grinding, but only to heating and the media mill-ultrasonic coupling system. The solubility of pea protein in this comparison is tested to be 88.45%, which is 10.71% lower than the solubility of modified pea protein in Embodiment 1 and 75.50% higher than the solubility of pea protein without any modification, indicating that the pre-treatment of the colloid mill has a certain effect on increasing the solubility of the protein.

### Comparison 6

This embodiment is the same as the method of Embodiment 1, with the difference that the pea proteins are not subjected to heating, but only to colloid mill grinding and the media mill-ultrasonic coupling system. The solubility of pea protein in this comparison is tested to be 70.83%, which is 28.33% lower than the solubility of modified pea protein in Embodiment 1 and 57.88% higher than the solubility of pea protein without any modification, indicating that the heating treatment has a significant effect on increasing the solubility of the protein.

### Comparison 7

This embodiment is the same as the method of Embodiment 1, with the difference that the pea protein is not treated with simultaneous ultrasonication, but with colloid mill grinding, heating, and a separate media mill device.

The solubility of pea protein in this comparison is tested to be 50.59%, which is 48.57% lower than the solubility of modified pea protein in Embodiment 1 and 37.64% higher than the solubility of pea protein without any modification, indicating that coupled ultrasound has a very significant effect on increasing the solubility of the protein.

### Embodiment 7: Media Mill-Ultrasonic Coupling System

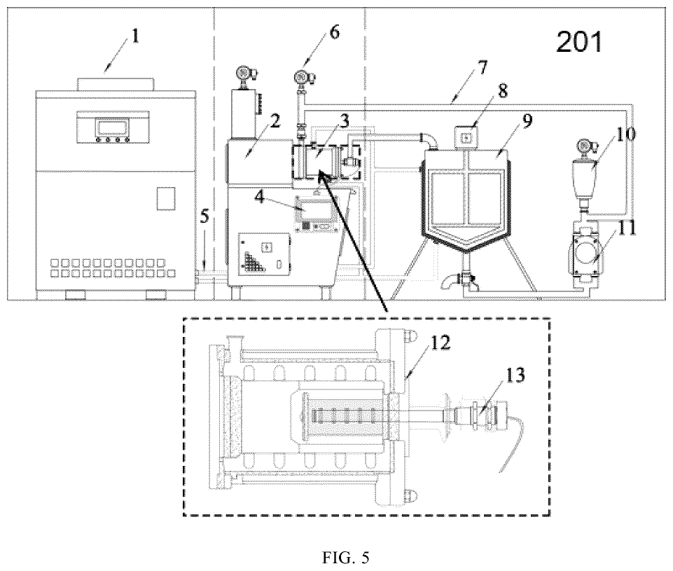

Referring to FIG. 5, the present disclosure provides a media mill-ultrasonic coupling system, including: a temperature control machine (1), a media mill-ultrasonic coupling device (201), the temperature control machine (1) and the media mill-ultrasonic coupling device (201) being connected through a temperature control water circulation pipeline (5); the media mill-ultrasonic coupling device (201) includes a grinding motor (2), a grinding chamber-ultrasonic coupling section (3), an ultrasonic control panel (4), a temperature gauge (6), a material liquid circulation pipeline (7), a feed barrel stirring motor (8), a feed barrel (9), a staging tank (10), and a circulation pump (11); where an end of the grinding chamber-ultrasonic coupling section (3) is connected to the grinding motor (2), and grinding is performed in the grinding chamber (12) by the grinding motor (2) driving a grinding part, and an ultrasonic generation device (13) is configured to perform an ultrasonic action in the grinding chamber (12); the temperature gauge (6) is arranged on an upper part of the grinding chamber, the grinding chamber is connected to the staging tank (10) through the liquid circulation pipeline (7), and the circulation pump (11) disposed below the staging tank is configure to drive to circulate the material liquid. The feed barrel (9) is connected to the grinding chamber through a feed pipe, and the feed barrel stirring motor (8) is arranged in the feed barrel.

### Comparison 8

Literature is reviewed to compare the effectiveness of modification of legume proteins, especially pea proteins, using ball milling treatment, ultrasonic treatment, heating treatment, and some emerging physical means in the prior art. The results are shown in Table 7 below, and it can be seen that the current techniques related to the present disclosure are all less effective in modifying legume proteins (mainly pea proteins) than the method of the present disclosure, including ball milling, ultrasound, and heating treatments. Meanwhile, pH cycling, as an effective method for modifying proteins at present, is still less effective than the modification effect of the method of the present disclosure. In summary, the effect of the method of the present disclosure for the modification of legume proteins is green and efficient.

TABLE 7
Survey of solubility of legume proteins after treatment by prior art

| | | | Literature |
|---|---|---|---|
| Treatment method | Protein | Solubility | source |
| Ball mill | Pea protein | 69.84% | [1] |
| | Soy protein | 40-50% | [2] |
| Ultrasonication | Pea protein | 55.80% | [3] |
| | Pea protein | 77% | [4] |
| Heating | Pea protein | 56.9% | [5] |
| | | 20-25% | [6] |
| pH cycling | Pea protein | 54.94% | [3] |
| | | 57.10% | [7] |
| pH cycling + | Pea protein | 60.83% | [3] |
| Ultrasonication | | 89.00% | [7] |
| pH cycling + | Pea protein | 79.00% | [7] |
| Heating | | | |
| pH cycling + | Pea protein | 90.4% | [7] |
| Ultrasonication + | | | |
| Heating | | | |
| High pressure | Chickpea | 44.8% | [8] |
| homogenization | protein | | |
| Microfluidization | Pea protein | 64.28% | [9] |

### Test Example 1: Determination of Solubility

The protein solutions described in Embodiments 1-5 and Comparisons 1-8 are taken, and the supernatant protein solution is obtained by centrifugation at 10000g for 20 min. The protein content in the supernatant and the protein content in the whole protein solution are measured by Kjeldahl method (the conversion factor for soy protein is 5.71, and the conversion factor for the remaining legume proteins, such as pea protein, mung bean protein, chickpea protein, etc., is 6.25), and the supernatant protein content is divided by the protein content in the uncentrifuged whole protein solution to obtain its solubility.

### Test Example 2: Determination of Particle Size

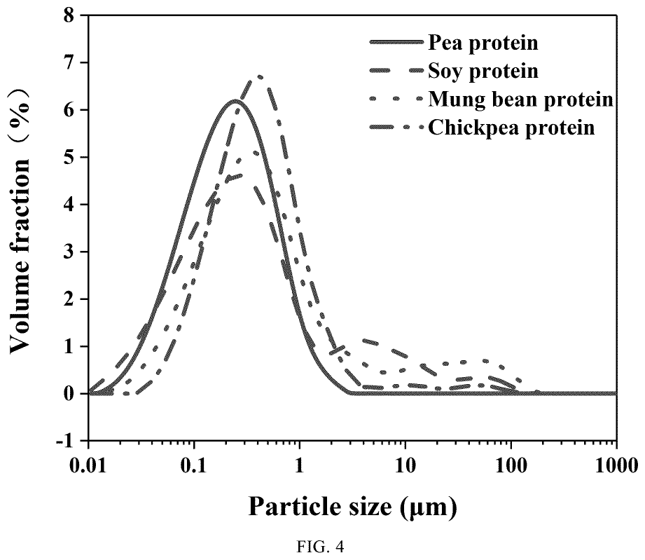

The particle size distribution of the protein in solution is determined by dynamic light scattering technique using a Malvern MasterSizer 3000 particle size meter to determine the particle size of the protein solution and its distribution (expressed as a percentage by volume). The measurement conditions are as follows: refractive index and absorption parameters are set to 1.520 and 0.01, respectively, and the shading range is 3-8%. The results of the determination are expressed using the curve of the relative volume ratio of the particles in relation to their average sizes, and the results are shown in FIG. 4. The solubility of protein in this method is closely related to its particle size, and the particle size distribution graph in FIG. 4 shows that after the protein is modified in a series of treatments, the particle size distribution of the treated legume protein is reduced to submicron level, indicating that the method of the present disclosure to enhance the solubility of legume protein is related to the modification of insoluble aggregates of legume protein into soluble small aggregates.

### Test Example 3: Colloidal Stability of Proteins

To the protein solution prepared by the method of the present disclosure, 0.02% sodium azide is added to attenuate the growth of microorganisms, after which the sample is placed in the refrigerator for 30 days, carefully removed and photographed, and their particle size is measured. Taking pea protein as an example, the result graph is shown in FIG. 3. After 30 days of resting storage, the protein solution treated by this method shows no delamination in appearance and shows no difference compared to day 1. In addition, there is a difference in the particle size of the protein solutions prepared at different treatment time, and the particle size tends to decrease as the treatment time increases. The change of particle size (D50) during storage is also very small and does not show a significant increase. The above results indicate that the highly soluble protein solution prepared by this method has excellent stability.

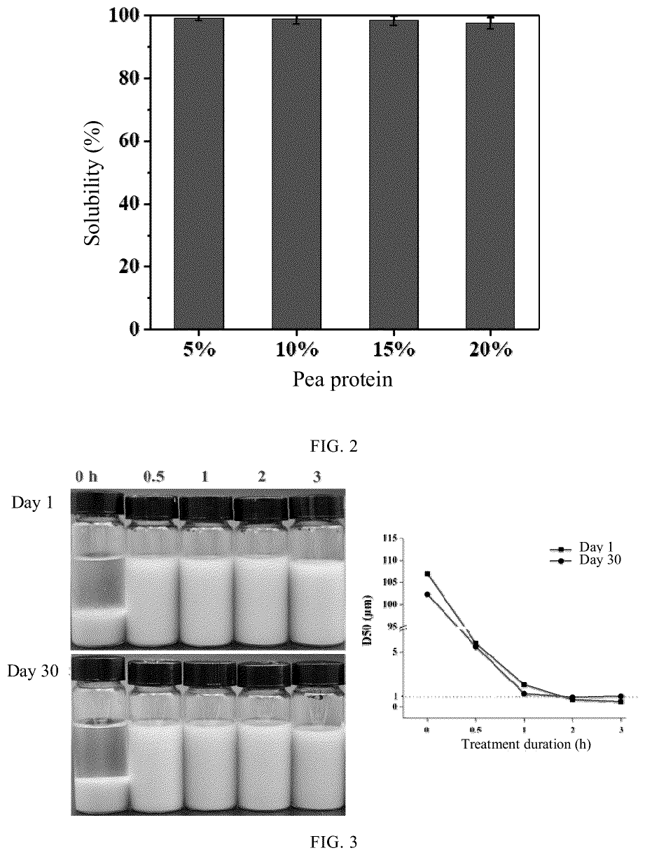

In summary, the present disclosure, by introducing a novel media mill-ultrasonic coupling system, enables a purely physical modification method to obtain a fully soluble commercial protein solution with solubility up to more than 98% at high initial concentrations of 5%-20% (FIG. 2), and the modification effect is even higher than that of enzymatic and chemical methods, which is unprecedented among physical modification means in the field of protein modification. The preparation method of the present disclosure does not introduce any reagent and is green, simple, and efficient, which is a major breakthrough in the field of protein modification technology.

It is apparent to those skilled in the art that the present disclosure is not limited to the details of the above exemplary embodiments and is capable of being realized in other specific forms without departing from the spirit or essential features of the present disclosure. Therefore, the embodiments should be considered exemplary and non-limiting from either point of view, and the scope of the present disclosure is limited by the appended claims and not by the above description, and is therefore intended to encompass all variations falling within the meaning and scope of the equivalent elements of the claims.

### REFERENCES

[1] Liu Q, Li Z, Pan X, et al. Effect of grinding on the structure of pea protein isolate and the rheological properties of its acid-induced gels[J]. International Journal of Food Science & Technology, 2021, 56(7): 3455-3462.
[2] Zhao X, Sun L, Zhang X, et al. Effects of ultrafine grinding time on the functional and flavor properties of soybean protein isolate[J]. Colloids and Surfaces B: Biointerfaces, 2020, 196:111345.
[3] Jiang S, Ding J, Andrade J, et al. Modifying the physicochemical properties of pea protein by pH-shifting and ultrasound combined treatments[J]. Ultrasonics Sonochemistry, 2017, 38:835-842.

[4] Sha L, Koosis A O, Wang Q, et al. Interfacial dilatational and emulsifying properties of ultrasound-treated pea protein[J]. Food Chemistry, 2021, 350:129271.
[5] Bogahawaththa D, Chau N H B, Trivedi J, et al. Impact of selected process parameters on solubility and heat stability of pea protein isolate[J]. LWT, 2019, 102:246-253.
[6] Ertugrul U, Namli S, Tas O, et al. Pea protein properties are altered following glycation by microwave heating[J]. LWT, 2021, 150:111939.
[7] Zhi Z, Yan L, Li H, et al. A combined approach for modifying pea protein isolate to greatly improve its solubility and emulsifying stability[J]. Food Chemistry, 2022, 380:131832.
[8] Huang Z, Wang X, Zhang J, et al. High-pressure homogenization modified chickpea protein: Rheological properties, thermal properties and microstructure[J]. Journal of Food Engineering, 2022, 335:111196.
[9] He X, Chen J, He X, et al. Industry-scale microfluidization as a potential technique to improve solubility and modify structure of pea protein[J]. Innovative Food Science & Emerging Technologies, 2021, 67:102582.

What is claimed is:

1. A method for preparation of fully soluble legume protein, wherein high-solubility legume protein is prepared by processing low-solubility legume protein with a physical method that combines grinding with ultrasound.

2. The method according to claim 1, comprising:
(1) providing legume protein, adding water and stirring to disperse evenly, and obtaining a protein dispersion;
(2) pouring the stirred homogeneous protein solution into a colloid mill for coarse grinding to obtain a coarse grinding solution;
(3) heating the coarsely grinding solution; and
(4) cooling the heated coarsely grinding solution, and pouring into a media mill-ultrasonic coupling system for grinding and ultrasonication;
wherein the protein solution that has been ground and ultrasonicated is the high-solubility legume protein.

3. The method according to claim 2, wherein in the step (1), the legume protein is un-pretreated legume protein with an initial solubility of 8%-20%.

4. The method according claim 3, wherein the legume protein is human and animal edible protein; the legume protein comprises one or more of pea protein, soy protein, mung bean protein, chickpea protein, black bean protein, lentil protein, fava bean protein, white kidney bean protein, navy bean protein, macaoba bean protein, butter bean protein, and lima bean protein.

5. The method according to claim 2, wherein in the step (1), a mass fraction of protein in the protein dispersion is in a range of 5%-20%; a stirring rate is 300-900 r/min and a stirring duration is 10-30 min.

6. The method according to claim 2, wherein in the step (2), a rotational speed of the colloid mill is 2000-4000 rpm, and the coarse grinding is performed for 1-3 times.

7. The method according to claim 2, wherein in the step (3), a heating temperature is 50-90° C. and a heating duration is 1-3 h.

8. The method according to claim 2, wherein in the step (4), a grinding media in the media mill is glass beads, ceramic beads, steel beads.

9. The method according to claim 8, wherein the grinding media is zirconia ceramic beads.

10. The method according to claim 2, wherein in the step (4), a grinding media in the media mill is zirconia beads, and a particle size of the zirconia beads is in a range of 0.1-2.5 mm; a filling rate of the grinding media in the grinding chamber is in a range of 30-80%.

11. The method according to claim 10, wherein the particle size of the zirconia beads is in a range of at least one of 0.2-2.0 mm, 0.8-1.8 mm, and 1.2-1.6 mm; the filling rate of the grinding media is in a range of 40-80%.

12. The method according to claim 2, wherein in the step (4), zirconia beads with a diameter of 0.2-2.0 mm are added to the grinding chamber, and a filling rate of the zirconia beads in the grinding chamber is 40%-80%; a motor speed in the grinding chamber is 600-1500 rpm; ultrasonic conditions comprises: a 10 mm diameter probe with a power of 800 W and a frequency of 35 kHz;
the coarse grinding solution is circulated for 0.5-3 h; a grinding temperature is controlled at 30-50° C.

13. The method according to claim 2, wherein in the step (5), the high-solubility legume protein has a solubility greater than 80%.

14. The method according to claim 13, wherein the solubility is greater than 98%.

15. A Fully soluble legume protein prepared by the method according to claim 1.

16. The legume protein according to claim 15, wherein the high-solubility legume protein has a solubility greater than 90%.

17. The legume protein according to claim 16, wherein the high-solubility legume protein has a solubility greater than 95%.

18. A media mill-ultrasonic coupling system, comprising: a temperature control machine (1), a media mill-ultrasonic coupling device (201), the temperature control machine (1) and the media mill-ultrasonic coupling device (201) being connected through a temperature control water circulation pipeline (5); the media mill-ultrasonic coupling device (201) comprises a grinding motor (2), a grinding chamber-ultrasonic coupling section (3), an ultrasonic control panel (4), a temperature gauge (6), a material liquid circulation pipeline (7), a feed barrel stirring motor (8), a feed barrel (9), a staging tank (10), and a circulation pump (11); wherein an end of the grinding chamber-ultrasonic coupling section (3) is connected to the grinding motor (2), and grinding is performed in the grinding chamber (12) by the grinding motor (2) driving a grinding part, and an ultrasonic generation device (13) is configured to perform an ultrasonic action in the grinding chamber (12); the temperature gauge (6) is arranged on an upper part of the grinding chamber, the grinding chamber is connected to the staging tank (10) through the liquid circulation pipeline (7), and the circulation pump (11) disposed below the staging tank is configure to drive to circulate the material liquid; the feed barrel (9) is connected to the grinding chamber through a feed pipe, and the feed barrel stirring motor (8) is arranged in the feed barrel.
